(19) United States
(12) Patent Application Publication
(10) Pub. No.: US 2026/0357975 A1
(43) Pub. Date: Nov. 12, 2026

(54) Lighting apparatus and method

(71) Applicant: Merrimack College, North Andover, MA (US)

(72) Inventor: Craig W. Looney, Haverhill, MA (US)

(21) Appl. No.: 19/668,110

(22) Filed: May 5, 2026

Related U.S. Application Data
(60) Provisional application No. 63/802,767, filed on May 9, 2025.

(51) Int. Cl. F21V 21/22

(52) U.S. Cl. CPC F21V 21/22

(57) ABSTRACT

Lighting apparatus and method. The lighting apparatus includes a frame supporting a transparent panel; a light source operable connected to the frame and configured to direct light into the transparent panel; and a structure supporting the frame. The lighting apparatus further includes a movement device configured to allow movement of the frame between a first position in which the transparent panel is positioned at least substantially adjacent to a wall portion, and a second position in which the transparent panel is positioned away from the wall portion to enable the lighting apparatus to function as a lightboard.

### CROSS REFERENCE TO RELATED APPLICATIONS

The present application claims the benefit of and priority to co-pending United States provisional application no. 63/802,767, filed on May 9, 2025, the content of which is hereby incorporated by reference as if set forth in its entirety herein.

### TECHNICAL FIELD

Embodiments described herein generally relate to lighting apparatuses and methods.

### BACKGROUND

A lightboard is a device that produces high-quality, visually-engaging instructional imagery such as videos. Lightboards typically include a pane of glass rimmed with a light source that shines light directly into the glass.

A presenter such as a lecturer may write on the glass pane with fluorescent markers while facing an imagery gathering device. The writing from the fluorescent markers is illuminated by light exiting the glass through residue of the fluorescent markers. In operation, it may appear as if the presenter is writing on air while facing the imagery gathering device. Lightboard imagery such as videos are often used to support pedagogical approaches or as resources for post-class study.

There are several challenges associated with using lightboards. Lightboards require dedicated space, which makes their use impractical in standard office or classroom environments. Lightboards also need to be stored elsewhere when not in use, which creates logistical challenges. Transporting lightboards between locations is also cumbersome and risks damaging the glass component of the lightboard.

A glassboard is a device used in offices, classrooms, or the like. Glassboards comprise a pane of glass that is typically mounted on a wall in a similar way as a whiteboard. Although glassboards have uses in certain applications, they lack the visual engagement capabilities of lightboards. This is particularly true for certain productions such as video-based productions.

A need exists, therefore, for apparatuses and methods that overcome the disadvantages associated with existing devices and techniques.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

According to one aspect, embodiments relate to a lighting apparatus. The lighting apparatus includes a frame supporting a transparent panel; a light source operably connected to the frame and configured to direct light into the transparent panel; a structure supporting the frame; and a movement device configured to allow movement of the frame between a first position in which the transparent panel is positioned at least substantially adjacent to a wall portion, and a second position in which the transparent panel is positioned away from the wall portion to enable the lighting apparatus to function as a lightboard.

In some embodiments, the movement device includes a hinged portion in operable connectivity with the wall portion and with the frame, wherein the hinged portion enables the lighting apparatus to move between the first position and the second position. In some embodiments, the lighting apparatus further includes a support wheel configured to support the frame and to assist in movement of the lighting apparatus between the first position and the second position.

In some embodiments, the movement device includes a portable rail assembly including an attachment mechanism configured to attach to the wall portion and a rail portion configured to engage the structure supporting the frame to enable movement of the frame.

In some embodiments, the movement device includes a rail portion in operable connectivity with the wall portion and the frame, wherein the movement of the rail portion enables the lighting apparatus to move between the first position and the second position.

In some embodiments, the movement device includes at least one wheel configured to move along a rail portion positioned below a floor surface.

In some embodiments, the lighting apparatus includes at least one of: a position detection device configured to detect a position of the transparent panel, or a sensor to gather a parameter regarding the environment surrounding the apparatus; and a control device configured to control output of the light source based on the detected position of the transparent panel or an output from the sensor.

In some embodiments, the movement device includes a base portion attached to the structure supporting the frame, and a plurality of wheels configured to enable movement of the base portion, wherein the base portion includes a telescoping portion configured to move the base portion between a contracted state corresponding to the first position, and an extended state corresponding to the second position.

In some embodiments, the movement device includes a base portion attached to the structure supporting the frame, and a plurality of roller bearings positioned to enable movement of the support structure relative to the base portion to change the center of mass of the lighting apparatus.

In some embodiments, the movement device include a base portion attached to the support structure, a plurality of wheels configured to enable movement of the base, and a telescoping arm portion configured to attach to the frame and to move the base portion between a contracted state corresponding to the first position, and an extended state corresponding to the second position.

According to another aspect, embodiments relate to a method of manufacturing a lighting apparatus. The method includes positioning a transparent panel in a frame; operably connecting a light source to the frame to direct light into the transparent panel; providing a structure to support the frame; configuring the structure or the frame with a movement device configured to allow movement of the frame between a first position in which the transparent panel is positioned at least substantially adjacent to a wall portion and a second position in which the transparent panel is positioned away from the wall portion to enable the lighting apparatus to function as a lightboard.

In some embodiments, the movement device includes a hinged portion in operable connectivity with the wall portion and with the frame, wherein the hinged portion enables the lighting apparatus to move between the first position and the second position. In some embodiments, the method further includes providing a support wheel to support the frame and to assist in movement of the lighting apparatus between the first position and the second position.

In some embodiments, the movement device includes a portable rail assembly including an attachment mechanism configured to attach to the wall portion and a rail portion configured to engage a portion of the structure supporting the frame and enable movement of the frame.

In some embodiments, the movement device includes a rail portion in operable connectivity with the wall portion and the frame, wherein the movement of the rail portion enables the lighting apparatus to move between the first position and the second position.

In some embodiments, the movement device includes at least one wheel configured to move along a rail portion positioned below a floor surface.

In some embodiments, the method further includes configuring the lighting apparatus with a position detection device configured to detect a position of the transparent panel and a control device configured to control output of the light source based on the detected position of the transparent panel.

In some embodiments, the method further includes attaching a base portion to the structure supporting the frame, and attaching a plurality of wheels configured to enable movement of the base portion, wherein the base portion includes a telescoping portion configured to move the base portion between a contracted state corresponding to the first position, and an extended state corresponding to the second position.

In some embodiments, the method further includes attaching a base portion to the structure supporting the frame and attaching a plurality of roller bearings positioned to enable movement of the support structure relative to the base portion to change the center of mass of the lighting apparatus.

In some embodiments, the method further includes attaching a base portion to the structure supporting the frame, attaching a plurality of wheels to the base portion to enable movement of the base portion, and attaching a telescoping arm to the frame to enable the base portion to be moved between contracted state corresponding to the first position, and an extended state corresponding to the second position.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIG. 1 illustrates a lighting apparatus in accordance with one embodiment;

FIG. 2 illustrates a lighting apparatus in accordance with another embodiment;

FIGS. 3A & 3B illustrate a lighting apparatus in accordance with another embodiment;

FIG. 4 illustrates a lighting apparatus in accordance with another embodiment;

FIG. 5 illustrates a lighting apparatus in accordance with another embodiment;

FIG. 6 illustrates a lighting apparatus in accordance with another embodiment;

FIG. 7 illustrates a lighting apparatus in accordance with another embodiment;

FIG. 8 illustrates a lighting apparatus in accordance with another embodiment;

FIG. 9 illustrates a lighting apparatus in accordance with another embodiment;

FIG. 10 illustrates a lighting apparatus in accordance with another embodiment;

FIG. 11 illustrates a lighting apparatus in accordance with another embodiment;

FIG. 12 illustrates a lighting apparatus in accordance with another embodiment;

FIG. 13 illustrates a lighting apparatus in accordance with another embodiment; and

FIG. 14 illustrates a system for operating a lighting apparatus in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

The present application provides novel designs for a convertible lighting apparatus that can function as a glassboard and a lightboard. The described embodiments eliminate the need for two separate devices (i.e., a separate lightboard and a separate glassboard), and solve the storage, operational, and logistics problems associated with existing devices.

The apparatuses described herein generally include a transparent panel, such as a glass pane, secured with a support structure. The support structure may be configured with one or more movement devices such as wheels, bearings, rollers, sliders, track portions, rail portions, etc., that enable the support structure or at least the glass pane to move between positions. One position may refer to a location in proximity to a wall portion in which the apparatus can operate as a glassboard. Another position may refer to a location away from the wall portion such that the apparatus operates as a lightboard.

The apparatuses described herein include, are configured with, or otherwise use various components such as rails, hinges, telescoping portions, subfloor mechanisms, or other types of hardware to control and limit the movement of the apparatus between positions. Specifically, these components of the described embodiments are included not only to temporary fix the apparatuses herein in certain positions or allow movement between positions, but to provide anti-tip stability as the apparatus is moved between positions. Accordingly, a user can move the apparatuses of various embodiments between positions safely and without the risk of the apparatus tipping over.

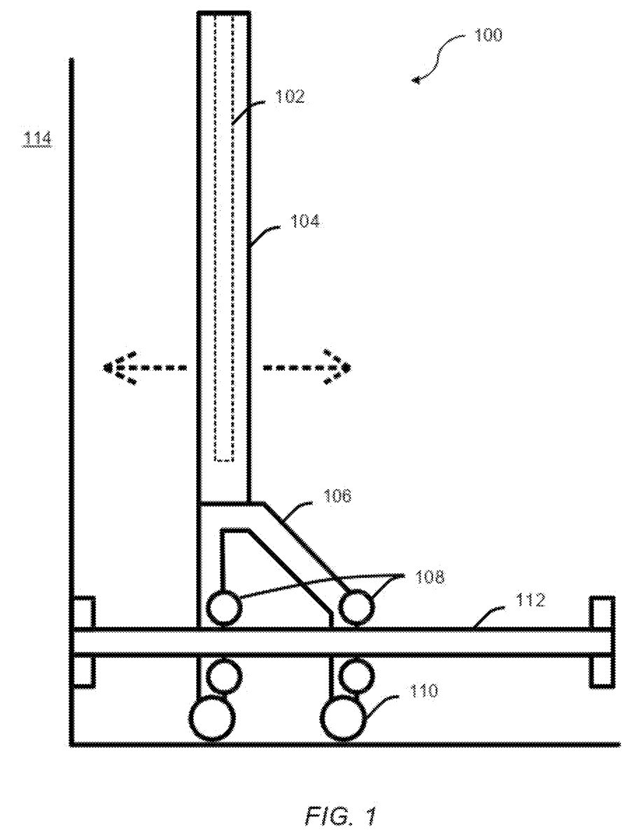

FIG. 1 illustrates a lighting apparatus 100 in accordance with one embodiment. The apparatus 100 includes a transparent panel (for simplicity, “glass pane”) 102 positioned within a support structure 104. The support structure 104 may comprise or include a frame portion to hold or otherwise secure the glass pane 102. The support structure 104 may also include or otherwise be configured with a base portion 106 with a plurality of track wheels 108. The base portion 106 may also be configured with a plurality of floor wheels 110 to enable movement of the apparatus 100 over a floor portion.

The embodiment of FIG. 1 also includes a rail portion 112 secured to one or more wall portions 114. The rail portion 112 may be configured with one or more grooves or tracks that are configured to be engageable by the track wheels 108. This allows a user to move the support structure 104 along the rail portion 112 while keeping the support structure 104 secured and preventing the support structure 104 from tipping over. In some embodiments, the rail portion may be at least temporarily fixed to a wall portion 114 to stabilize the apparatus 100 and prevent the apparatus 100 from tipping over. Accordingly, the rail portion 112 provides anti-tip stability for the apparatus in either position, as well as when the apparatus 100 is being moved between positions.

The apparatus 100 may be located at a first position toward the wall portion 114. In this position, the apparatus 100 may operate as a glassboard. A user may move the support structure 140 along the rail portion 112 to a second position that is further away from the wall portion 114 than the first position. In this position, the apparatus 100 may operate as a lightboard. The track wheels 108, floor wheels 110, rail portion 112, or some combination thereof, may include locking mechanisms to prevent unwanted movement of the support structure 104. In this position, the apparatus 100 may operate as a conventional or illuminated glassboard.

Although not explicitly shown in FIG. 1 or the following figures, the lighting apparatuses of the described embodiments may be configured with one or more light-emitting diode (LED) strips, such as ultraviolet light-emitting diodes. The embodiments described herein are not limited to any particular lighting source, however. Any other type of light source may be implemented in accordance with the described embodiments as long as they can provide lighting such that the apparatus can operate as a lightboard.

Although FIG. 1 and other figures below are described with a “rail” or “rail portion,” any sort of suitable guiding devices may be used in accordance with the described embodiments. For example, any sort of channel, track, slot, guides, etc., whether available now or invented hereafter may be implemented in accordance with the described embodiments as long as they can enable the desired movement of the lighting apparatuses described herein. Similarly, although FIG. 1 and other figures below describe various types of “wheels,” any sort of wheels, bearings, or other wheel-based designs may be implemented in accordance with the described embodiments. Similarly, in some embodiments non-wheel or “frictionless” techniques for enabling movement of devices may be implemented as long as they can enable the desired movement of the lighting apparatuses described herein.

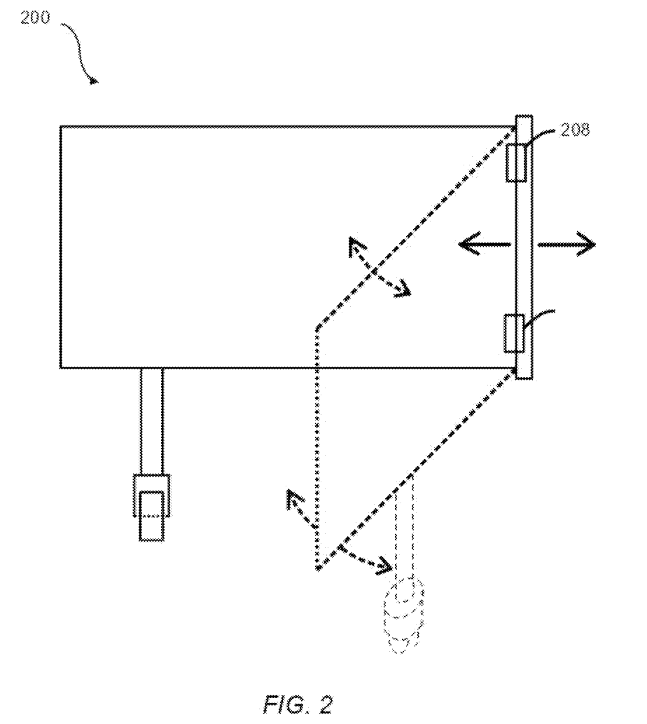

FIG. 2 illustrates a lighting apparatus 200 in accordance with another embodiment. The apparatus 200 includes a glass pane 202 that is mounted via a support structure 204 to a wall portion 206. The glass pane 202 is pivotally attached to the support structure 204 by one or more hinges 208. The hinges 208 allow the glass pane 202 to rotate about the support structure 204 to move between a first position corresponding to a glassboard mode, and a second position corresponding to a lightboard mode.

The glassboard mode may refer to the position in which the glass pane 202 is toward, against, or otherwise parallel with the wall portion 206. In this position, a user may write on the glass pane 202 as they would a typical glassboard. The user may temporarily secure the glass pane 202 in this position via a locking mechanism (e.g., a slide-and-lock mechanism, not shown in FIG. 2).

In some embodiments, the support structure 204 may be configured with one or more wheels or sliding devices that engage a track portion in the wall portion 206. This allows a user to slide the glass pane 202 to various locations against the wall portion 206 so that the user can operate the apparatus 200 in glassboard mode, lightboard mode, or both, at different locations on the wall portion 206.

To operate the apparatus 200 in lightboard mode, the user may move the glass pane 202 about the support structure 204 to move the glass pane 202 away from the wall portion 206. For example, the user may rotate the glass pane 202 about the support structure 204 such that the glass pane 202 is not parallel to the wall portion 206.

The apparatus 200 may include a leg portion 210 with a wheel 212 (e.g., a caster wheel) to assist in this rotational movement of the glass pane 202. The leg portion 210 and the wheel 212 act as support so that weight of the glass pane 202 is not acting entirely on the hinges 208, particularly during movement of the glass pane 202 between the first and second positions.

The apparatus 200 may further include one or more locking mechanisms to lock the glass pane 202 in the position corresponding to the lightboard mode. For example, the wheel 212 may be configured with a locking mechanism to prevent movement of the wheel 212 and therefore the glass pane 202. Additionally or alternatively, the support structure 204 may be configured with a locking mechanism to lock the glass pane 202 in a certain position.

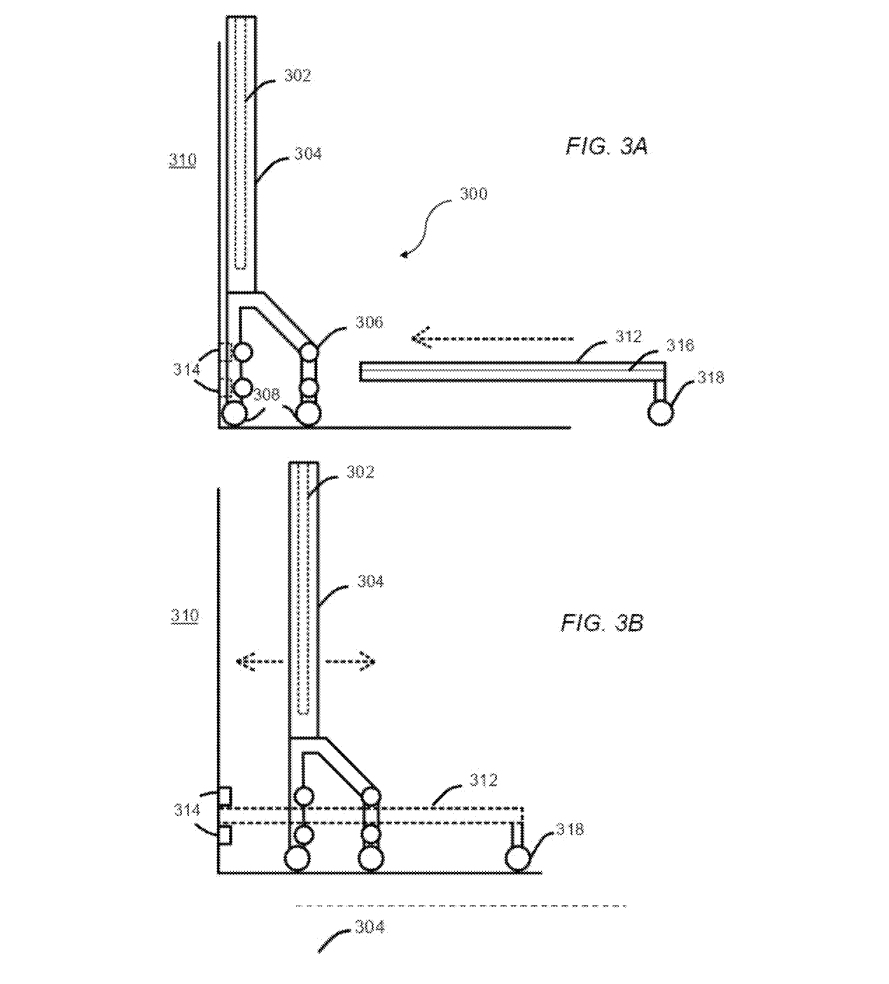

FIGS. 3A & 3B illustrate a lighting apparatus 300 in accordance with another embodiment. In this embodiment, a glass pane 302 may be supported by a support structure 304 that is configured with one or more track wheels 306 and floor wheels 308. The floor wheels 308 may include caster wheels and enable the support structure 304 to move towards and away from a wall portion 310.

A rail support 312 provides a removable design for stabilizing the glass pane 302 and the support structure 304. FIG. 3A illustrates the apparatus 300 in a first position corresponding to the glassboard mode. The wheels 308 may be configured with a locking mechanism to lock the support structure 304 in this position. Additionally or alternatively, the support structure 304 may be temporarily connected with to the wall portion 310 via one or more wall mounts 314 to secure the support structure 304 in the first position.

To move the support structure 304 into a second position corresponding to the lightboard mode, a user may first position the rail support 312 such that tracks 316 of the rail support 312 engage the track wheels 306 of the support structure 304. The rail support 312 may be configured with one or more support wheels 318 to enable movement thereof. The support wheels 318 enable a user to slide the rail support 312 between the track wheels 306, while ensuring that the end of the rail support 312 is supported by the floor.

The user may continue to slide or otherwise roll the rail support 312 toward the wall portion 310 until the rail support 312 engages and secures itself with the wall mount 314. The wall mount 314, the rail support 312, or some combination thereof may be configured with a quick-release mechanism to enable the rail support 312 to be removably connected with the wall mount 314. For example and without limitation, the rail support 312 and the wall mount 314 may be connected with each other via a pin-and-lock device, a spring-loaded device, hand-knob bold, a button-release combination, or the like.

As seen in FIG. 3B, once the rail support is connected with the wall mount 312, the a may slide the support structure 304 along the rail support 312 and away from the wall portion 310. The user may move the support structure to the desired location along the rail support 312 to a second position corresponding to the lighting board mode. The user may then activate any locking devices to secure the support structure 304 at the desired position along the rail support 312.

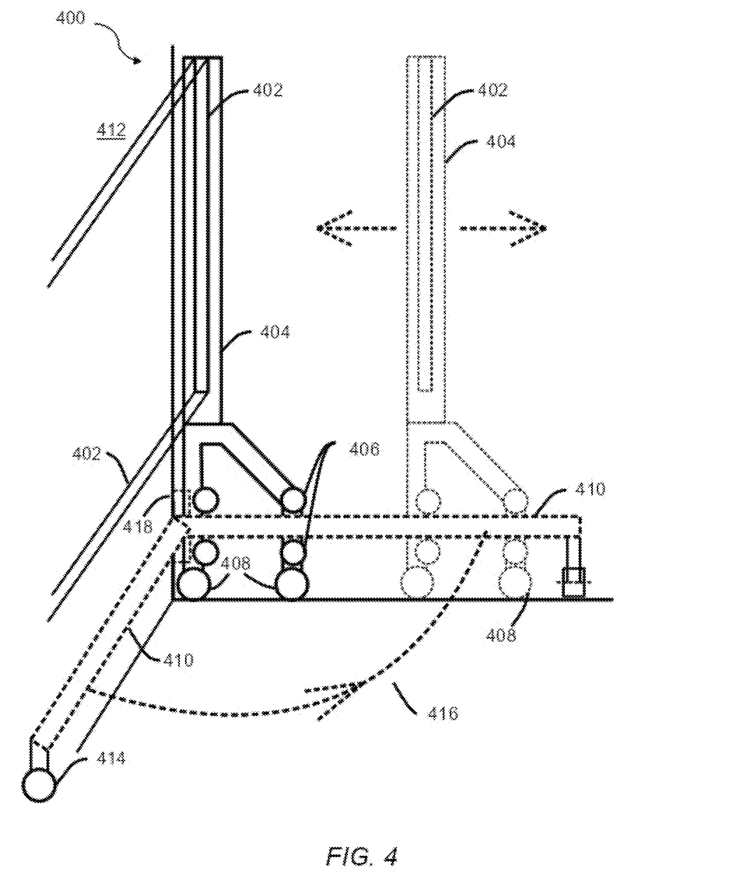

FIG. 4 illustrates a lighting apparatus 400 in accordance with another embodiment. In this embodiment, the apparatus 400 may include a glass pane 402 supported by a support structure 404 that is configured with one or more track wheels 406 and floor wheels 408. The track wheels 406 may engage or otherwise connect with a track portion of a rail support 410 discussed below. The floor wheels 408 may include caster wheels and enable the support structure 404 to move towards and away from a wall portion 412.

The apparatus 400 may be similar to the apparatus 300 of FIGS. 3A & 3B. However, the rail support 410 is configured to “swing” between a position in which the rail support 410 is parallel to the wall portion 412, and a position in which the rail support 410 is not parallel with the wall portion 412. For example, the rail portion 410 may move to a position that is perpendicular to the wall portion 412.

In the first position corresponding to the glassboard mode, the support rail 410 may be positioned against the wall portion 412 and under the glass pane 402. The rail portion 410 may be configured with one or more wheels 414 and be configured to move along the path 416 from against the wall portion 412 to a second position to, for example, become perpendicular with the wall portion 412.

In this perpendicular position, a track portion on the rail portion 410 may engage the track wheels 406 of the support structure 404. For example, when it is time to operate the apparatus 400 in lightboard mode, the top track wheels 406 could be raised and temporarily locked in place while the rail portion 410 is repositioned. A bottom portion of the rail portion 410 could be flush with the bottom wheels of the track wheels 406, and the top wheels of the track wheels 406 could be lowered into a channel on the rail portion 410. The rail portion 410 may remain pivotally connected to one or more wall mounts 418 in either position, as well as during movement between positions.

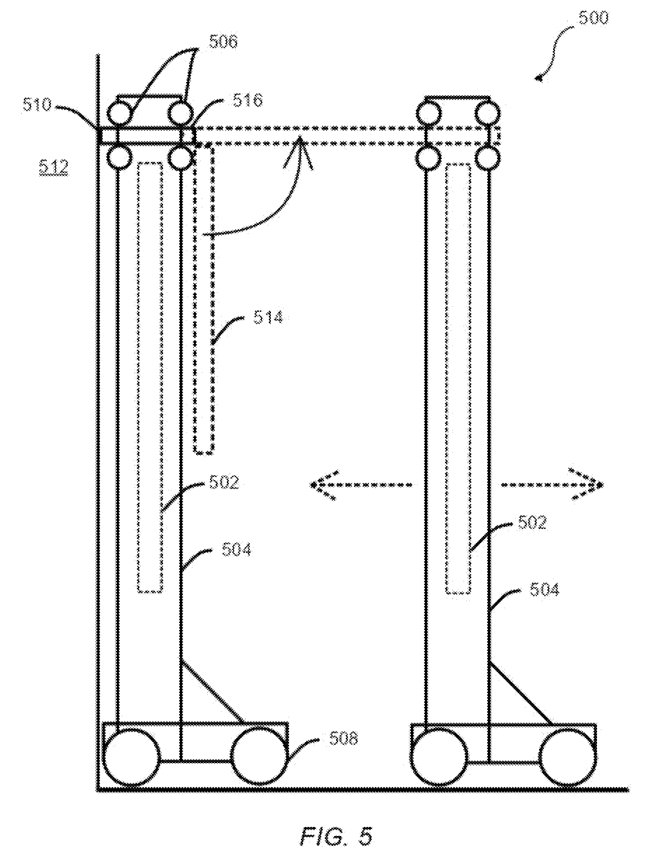

FIG. 5 illustrates a lighting apparatus 500 in accordance with another embodiment. In this embodiment, the apparatus 500 may include a glass pane 502 supported by a support structure 504 that is configured with one or more track wheels 506 and floor wheels 508 such as caster wheels.

In this embodiment, the track wheels 506 may be positioned toward the top of the support structure 504 and configured to engage a mount 510 secured to a wall portion 512. The mount 510 may include one or more track portions to receive the track wheels 506. In some embodiments, the mount 510 or the track wheels 506 may include a locking mechanism to prevent movement of the track wheels 506 while the support structure 504 is in proximity to the wall portion 512 at which the apparatus 500 can operate in a glassboard mode.

The apparatus 500 may further include one or more rail portions 514 positioned and configured to swing up via a hinge 516 and lock in a position that is parallel to the floor and perpendicular to the wall portion 512. The rail portion(s) 514 may have substantially the same profile as a portion of the mount 512 such that the track wheels 506 can slide over the mount 510 and across the rail portion 514. The hinge 516 may be a low-profile hinge so as to not disrupt the movement of the track wheels 506. This enables the user to move the support structure 504 away from the wall portion 512 to a second position in which the user can operate the apparatus 500 in lightboard mode.

The rail portion(s) 514 may be positioned toward the perimeter or otherwise the side of the glass pane 502 and the support structure 504. Additionally, the base portion of the support structure 504 may be smaller than in other embodiments where the rail portions are located below the center of mass of the respective support structures and glass panes.

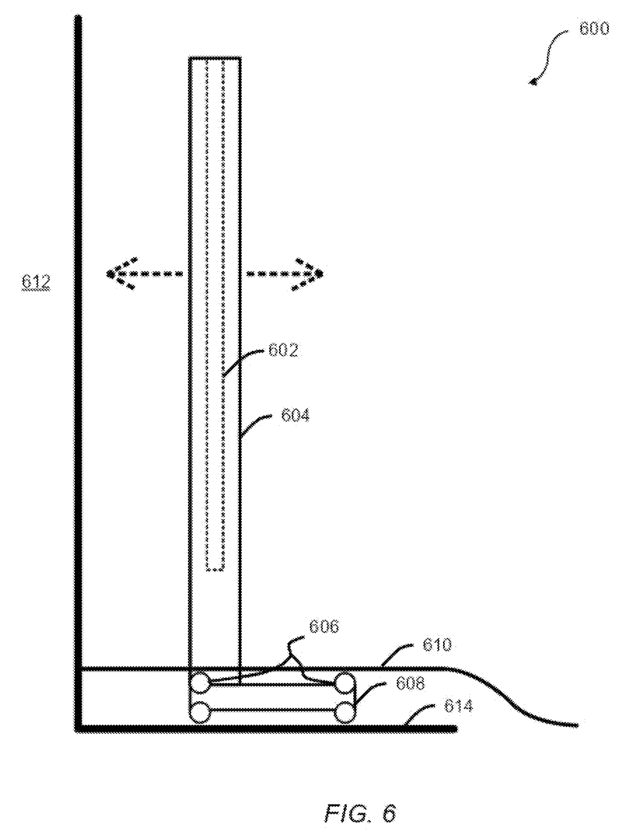

FIG. 6 illustrates a lighting apparatus 600 in accordance with another embodiment. In this embodiment, the apparatus 600 may include a glass pane 602 supported by a support structure 604 that is configured with one or more wheels 606. The wheels 606 may be configured with a base portion 608 that is positioned below a raised surface 610. In this embodiment, users or other personnel may walk or stand on a portion of the raised surface 610.

The base portion 608 may enable the apparatus 600 to be moved toward and away from the wall portion 612 by traveling over a floor surface 614. The floor surface 614 may include one or more track portions configured to permit desired movement and prevent unwanted movement of the wheels 606 of the base portion 608. Additionally or alternatively, the lower face of the raised surface 610 may include one or more track portions or channels configured to permit desired movement and prevent unwanted movement of the wheels 606 of the base portion 608.

A user may position the apparatus 600 toward or otherwise at least substantially adjacent to a wall portion 612 to operate the apparatus 600 in glassboard mode. The apparatus 600 may also be configured with any sort of mechanisms or devices to temporarily secure the apparatus 600 in the first position corresponding to the glassboard mode.

The combination of the wheels 606 and any track portions enable the user to move the apparatus 600 away from the wall portion 612 and to a second position such that the apparatus 600 can operate in lightboard mode. The apparatus 600 may include any suitable locking mechanisms to prevent unwanted movement of the apparatus 600 while operating in lightboard mode.

The configuration of the base portion 608 and the wheels 606 may vary. In some embodiments, the base portion 608 may be configured only with wheels that contact the floor portion 614. The size of the wheels 606 may vary as well (e.g., as measured by their diameter), and may affect the overall height of the apparatus 600. For example, larger-diameter wheels 606 will cause the overall height of the apparatus 600 to be higher than smaller-diameter wheels. The raised surface 610 may comprise one or more removable panels to enable access to the base portion 608 for servicing. This may allow a user to, for example, replace one or more of the wheels 606 or even remove the base portion 604.

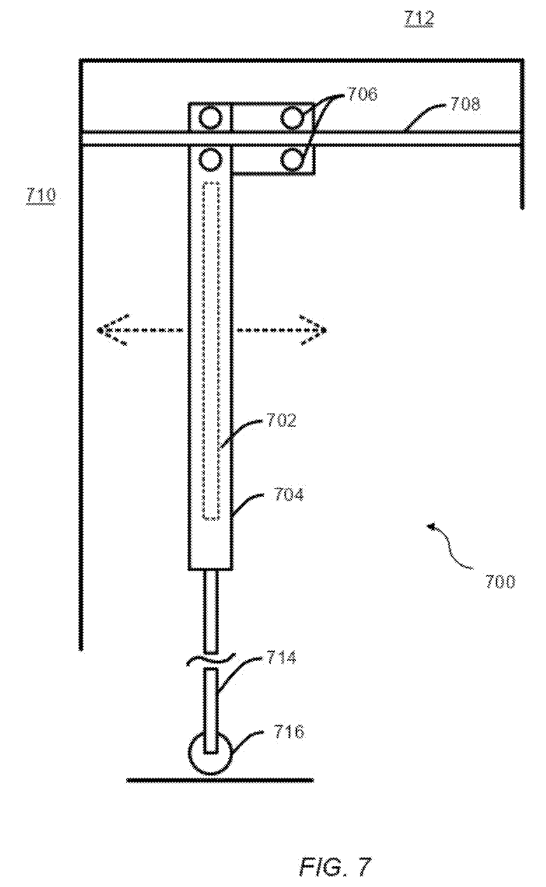

FIG. 7 illustrates a lighting apparatus 700 in accordance with another embodiment. The apparatus 700 may include a glass pane 702 supported by a support structure 704 including one or more track wheels 706. The apparatus 700 may further include one or more overhead rail portions 708 extending from a wall portion 710 and parallel with a ceiling portion 712.

The rail portion 708 may include one or more track portions configured to receive and enable movement of track wheels 706. For example, the rail portion 708, as well as other rail portions or related components described herein, may comprise a strut channel, T-slotted aluminum or other suitable material or configuration, etc.

The rail portion 708 may hang from the ceiling portion 712 by ceiling hangers or hanger wires, or other type of supports (not shown in FIG. 7). In some embodiments, the rail portion 708 may be configured as part of a dropped ceiling. In some embodiments, the rail portion 708 may bear almost the entirety of the weight of the apparatus 700.

In some embodiments, however, the apparatus 700 may further include one or more leg supports 714 and wheels 716. The wheel(s) 716 may decrease the amount of weight the overhead rail portion 710 would need to bear. Support wheels 716, particularly if they’re configured with a locking mechanism, may also prevent unwanted deflection or “sway” of the apparatus 700. The leg supports 714 may also include any suspension components, telescoping portions, etc., to accommodate for varieties of heights or irregularities in the floor surface.

The combination of the track wheels 706 and any support wheels 716 enable the apparatus 700 to be positioned adjacent to a wall portion 710 in a first position corresponding to the glassboard mode. The wheels 706 and support wheels 716 enable the user to move the apparatus 700 away from the wall portion 710 and to a second position corresponding to the lightboard mode. The apparatus 700 may include any suitable locking mechanisms to prevent unwanted movement of the apparatus 700 while operating in lightboard mode.

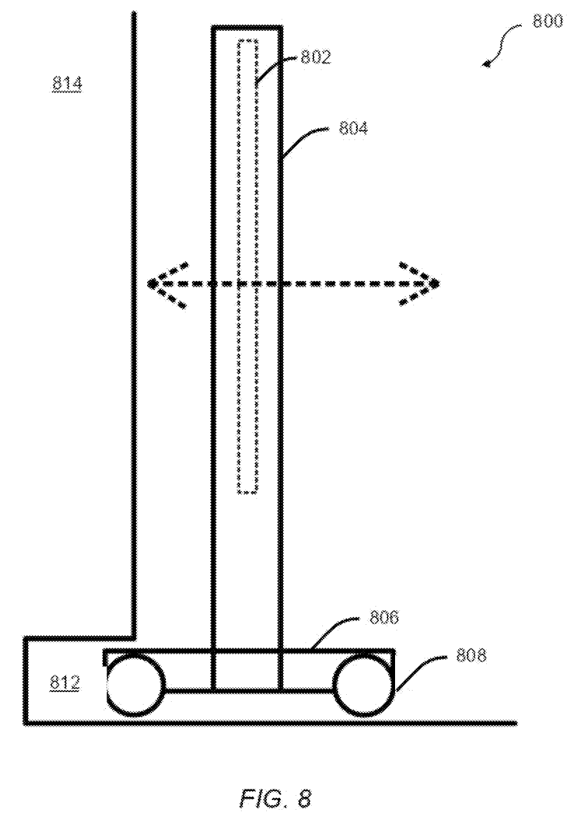

FIG. 8 illustrates a lighting apparatus 800 in accordance with another embodiment. The apparatus 800 may be considered a freestanding or otherwise a self-supporting apparatus and include a glass pane 802 supported by a support structure 804. The apparatus 800 may include a wider base portion 806 as compared to the vertical portion of the support structure 804 and be configured with a plurality of wheels 808. The wheels 810 may be positioned such that pairs thereof are positioned on opposite sides of the vertical portion of the support structure 804.

The apparatus 800 may function as a glassboard in an environment in which there is a recessed area 812 of a wall portion 814. As seen in FIG. 8, a segment of the base portion 806 may fit into the recessed area 812 to position the glass pane 802 adjacent to the wall portion 814. In this position, the apparatus 800 may operate as a glassboard. The recessed area 812 may function as a shelving unit such that the extended area on the opposite side of the wall portion 814 is not disruptive.

The wheels 808 enable the user to move the apparatus 800 away from the wall portion 814 and to a second position corresponding to the lightboard mode. The apparatus 800 may include any suitable locking mechanisms to help keep the apparatus 800 from moving while operating in lightboard mode.

In some embodiments, the wheels 808 may be caster wheels and may operate in a swiveling or non-swiveling mode. For example, the user may adjust any locking mechanisms one the caster wheel(s) such that they cannot swivel while in glassboard mode. The user may unlock the wheel(s) to allow the wheels to swivel or move freely when the user moves the apparatus 800 to a position to operate the apparatus 800 in lightboard mode. This may be true for other embodiments described herein.

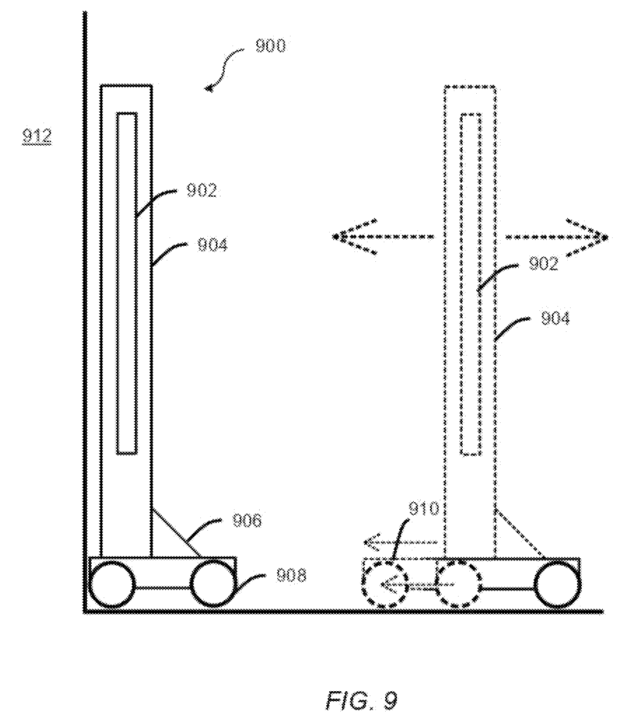

FIG. 9 illustrates a lighting apparatus 900 in accordance with another embodiment. The apparatus 900 may be considered a freestanding or otherwise a self-supporting apparatus and include a glass pane 902 supported by a support structure 904. As with the apparatus 800 of FIG. 8, the apparatus 900 may include a base portion 906 with a plurality of wheels 908. However, the base portion 906 may include a telescoping portion 910 attached to one or more of the wheels 910.

The telescoping portion 910 may be in a collapsed state while the apparatus 900 is in a first position adjacent to a wall portion 912 such as in a glassboard mode. As the apparatus 900 moves way from the wall portion 912, rear wheel(s) (i.e., the wheel(s) closest to the wall portion 912) remain in place until the telescoping portion 910 is fully extended, at which point the base portion 906 locks in place and operates similarly to the apparatus 800 of FIG. 8. In some embodiments, the rear wheels maintain a stationary position because they are locking casters in a locked position.

A user may then operate the apparatus 900 in lightboard board. The user may similarly move the apparatus to different positions as the wheels 908 may enable movement of the apparatus 900.

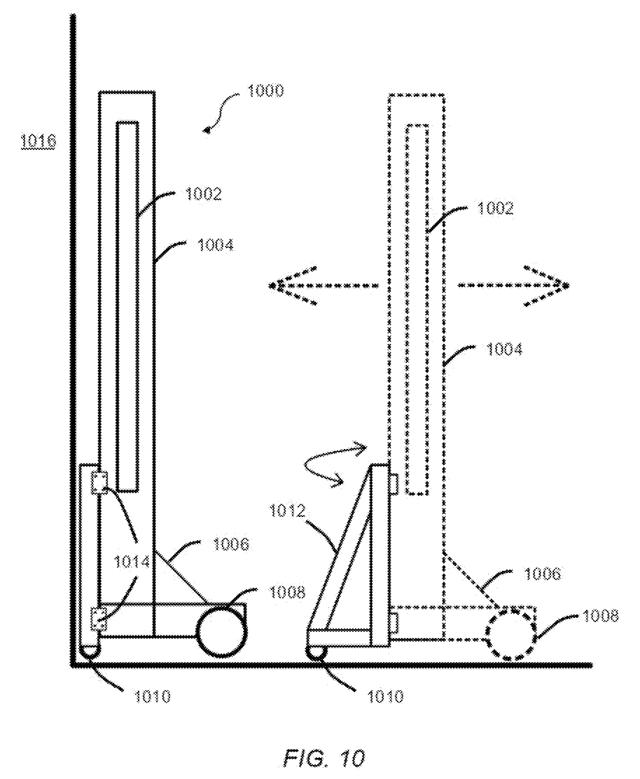

FIG. 10 illustrates a lighting apparatus 1000 in accordance with another embodiment. The apparatus 1000 may include a glass pane 1002 supported by a support structure 1004. The support structure 1004 may be configured with or otherwise connected to a base portion 1006 with front wheels 1008 and fold-out, rear wheels 1010. The rear wheels 1010 may be operably connected to a frame portion 1012 that is pivotally attached to the support structure 1004 via one or more hinges 1014.

The apparatus 1000 may be positioned toward a wall portion 1016 in a first position corresponding to the glassboard mode. In this position, the frame portion 1012 may be in a folded or retracted position such that the base portion 1006 is asymmetric. This position of the frame portion 1012 allows the base portion 1006 to be sufficiently close to the wall portion 1016 to operate in glassboard mode.

When a user wants to use the apparatus 1000 in lightboard mode, the user may pull the support structure 1004 away from the wall portion 1016. The rear wheels 1010 may fold out as the apparatus 1000 is being pulled away from the wall portion 1016. For example, the rear wheels 1010 may fold out automatically if they are spring-loaded, or manually by the user. The frame portion 1012 and the rear wheels 1010 stabilize the apparatus 1000 when they are in an extended position.

In some embodiments, there may be additional wheels underneath the apparatus 1000 and just behind the center of mass of the apparatus 1000. As in other embodiments, the wheels 1008 and 1010 may be configured as multi-directional to allow for easy multi-directional movement of the apparatus 1000. For example, one or more of the wheels 1008 or 1010 may be configured to “swivel” so as to enable the apparatus 1000 to move in various directions.

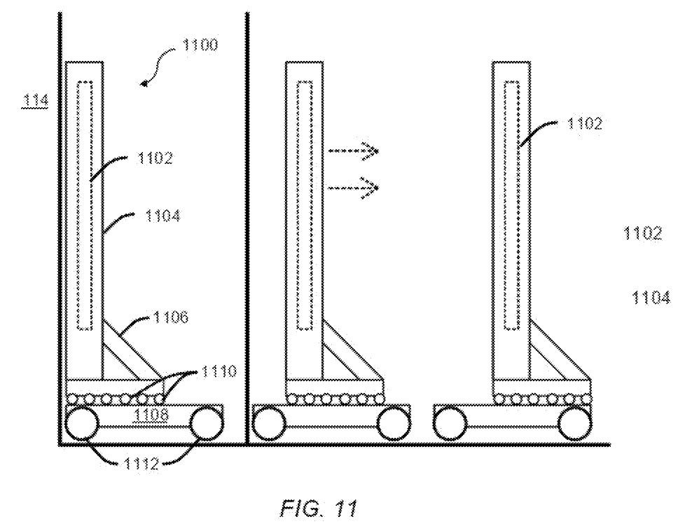

FIG. 11 illustrates a lighting apparatus 1100 in accordance with another embodiment. The apparatus 1100 may include a glass pane 1102 supported by a support structure 1104. A base portion 1106 of the apparatus 1100 may be capable of moving along various locations of a platform 1108. For example, there may be wheels 1110, bearings, rollers (for simplicity, “base wheels 1110”) positioned between the base portion 1106 and the platform 1108 that enable movement of the base portion 1106. The platform 1108 may also be configured with one or more wheels 1112 to enable movement of the apparatus 1110 to and away from a wall portion 1114.

In this embodiment, the apparatus 1110 may be positioned against the wall portion 1114 to operate in glassboard mode. Specifically, the platform 1108 may be positioned close to or even in contact with the wall portion 1114. Similarly, the support structure 1104 may be positioned close to or even in contact with the wall portion 1114. The support structure 1104, the platform 1108, or both, may be temporary locked or fixed in this position.

To operate the apparatus 1100 in lightboard mode, a user may first move the support structure 1104 away from the wall portion 1114. Specifically, the user may move the support structure 1104 to a different position on the platform 1108 away from the wall portion 1114. The platform 1108 may remain stationary during this movement of the support structure 1104. This movement changes the center of mass of the apparatus 1100. In this position, the center of mass of the apparatus 1100 is positioned at least approximately over the center of the platform 1108.

Once the support structure 1104 is positioned such that the glass pane 1102 is over approximately the center of the platform 1108, the user may engage any locking mechanisms to enable movement of the platform 1108. The user may move the platform 1108 away from the wall portion 1114 such that the apparatus 1100 can operate in lightboard mode.

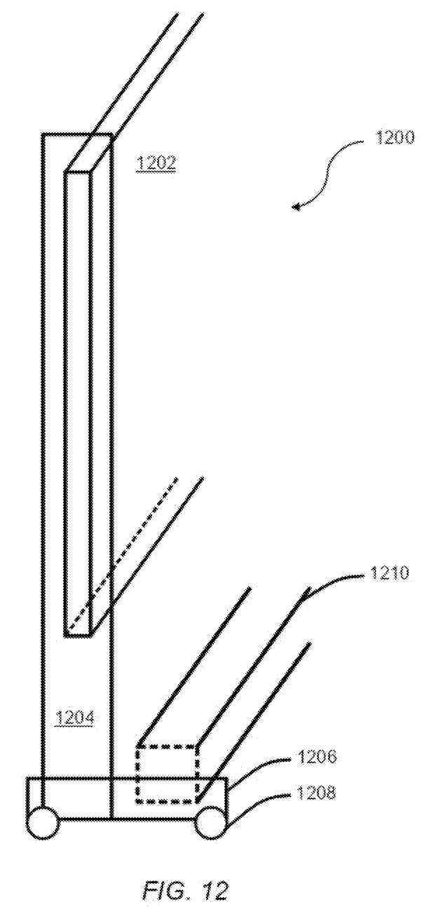

FIG. 12 illustrates a lighting apparatus 1200 in accordance with another embodiment. The apparatus 1200 may include a glass pane 1202 supported by a support structure 1204. The support structure 1204 may be operably connected to a base portion 1206 with a plurality of wheels 1208 to enable movement of the apparatus 1200. The apparatus 1200 may also include or otherwise be configured with a beam 1210. The beam 1210 may be secured to the base portion 1206 via any suitable means. The beam 1210 provides additional mass to the apparatus 1200 so as to change the center of mass of the apparatus 1200 and therefore enable the apparatus 1200 to be free standing. The beam 1210 may be of any shape, size, or weight as long as it can cause the center of mass of the apparatus 1200 to be located such that the apparatus 1200 can be freestanding.

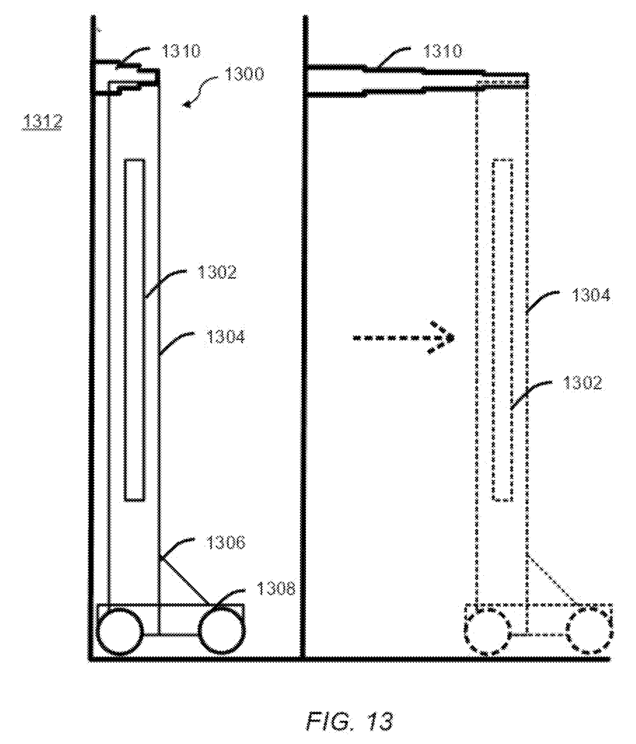

FIG. 13 illustrates a lighting apparatus 1300 in accordance with one embodiment. The apparatus 1300 may include a glass pane 1302 supported by a support structure 1304. The support structure 1304 may be operably connected to a base portion 1306 with a plurality of wheels 1308 to enable movement of the apparatus 1200. The apparatus 1300 may also include or otherwise be configured with a telescoping portion 1310 that is connectable to the support structure 1304 and a wall portion 1312.

The apparatus 1300 may be positioned against or otherwise close to the wall portion 1312 such that a user can operate the apparatus 1300 in a glassboard mode. The telescoping portion 1310, the wheel(s) 1308, or both, may be configured with a locking mechanism to prevent unwanted movement. In this position, the telescoping portion 1310 may be in a collapsed or folded position.

To operate the apparatus 1300 in lightboard mode, the user may release any applicable locking mechanisms and move the apparatus 1300 away from the wall portion 1312. As seen in FIG. 13, this movement will cause the telescoping portion 1310 to extend. The apparatus 1300 may move away from the wall portion 1312 until the telescoping portion 1310 is fully extended.

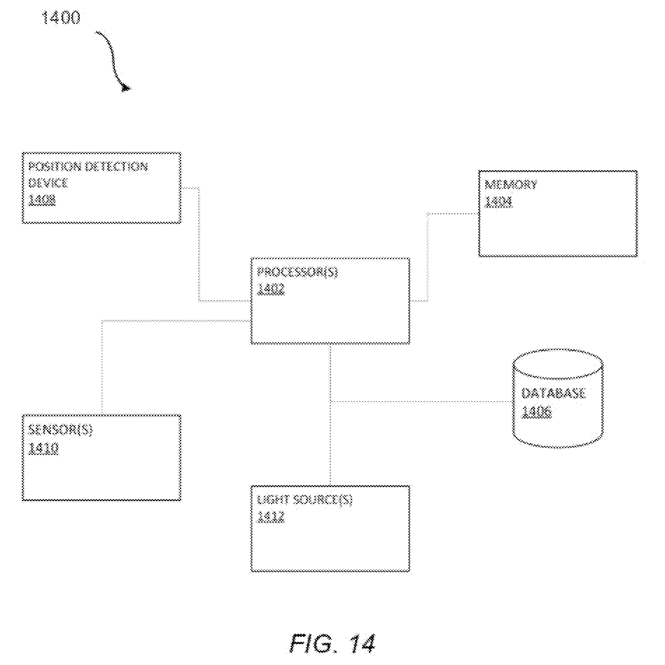

FIG. 14 illustrates a system 1400 for operating a lighting apparatus in accordance with one embodiment. The components of the system 1400 may be configured with or otherwise in operable connectivity with any one or more of the lighting apparatuses described herein.

The system 1400 may include one or more processors 1402 executing instructions stored in memory 1404 and in communication with one or more databases 1406. The system 1400 may also include a position detection device 1408, one or more sensor(s) 1410, and one or more light sources 1412. Although not shown in FIG. 14, the apparatuses described herein may also be configured with one or more power sources, such as to power the lighting sources 1412.

The processor(s) 1402 may be any hardware device capable of executing instructions stored on memory 1404 to accomplish the features of the disclosed embodiments. The processor 1402 may include a microprocessor, a field programmable gate array (FPGA), an application-specific integrated circuit (ASIC), or other similar devices.

In some embodiments, such as those relying on one or more ASICs, the functionality described as being provided in part via software may instead be configured into the design of the ASICs and, as such, the associated software may be omitted. The processor 1402 may be configured as part of the lighting apparatus or located at some remote location from the lighting apparatus.

The memory 1404 may be L1, L2, L3 cache, or RAM memory configurations. The memory 1404 may include non-volatile memory such as flash memory, EPROM, EEPROM, ROM, and PROM, or volatile memory such as static or dynamic RAM, as discussed above. The exact configuration/type of memory 1404 may vary as long as the processor(s) 1402 can execute instructions for operating the lighting apparatus.

The database 1406 may store data regarding particular users and their preferences. For example, the database 1406 may store data regarding a user’s preferred lighting conditions or output parameters of the light sources 1412.

The position detection device 1408 may monitor or otherwise detect the position of the lighting apparatus. For example, the position detection device 1408 may detect when the apparatus is positioned in a location that corresponds to the glassboard mode or otherwise not the lightboard mode. Similarly, the position detection device 1408 may detect when the apparatus is in a position or location corresponding the lightboard mode.

The position detection device 1408 may detect the position of the apparatus with respect to the wall portion. For example, the position detection device may detect if or when an apparatus as adjacent to a wall portion such that the apparatus is to be operated in glassboard mode or otherwise not in lightboard mode. In some embodiments, the position detection device 1408 may be configured as a weight scale or pressure transducer configured to detect the weight of the apparatus. For example, the position detection device 1408 may be scale placed several feet away from a wall portion such that, upon measuring a weight that is indicative of the apparatus, the processor 1402 may recognize that the apparatus is positioned at a location corresponding to the lightboard mode.

The processor(s) 1400 may control lighting output of the light sources 1412. For example, the processor(s) may control lighting intensity of the light sources, the color of light emitted by the light sources, etc. In some embodiments, this control may be based on the detected position of the apparatus.

This control may be based on other parameters of the environment surrounding the apparatus, as indicative by data gathered by one or more sensors 1410. The sensors 1410 may detect ambient conditions of the ambient environment in which the apparatus is located. For example, the sensors 1410 may detect conditions such as temperature, humidity, lighting conditions, (e.g., from other lighting sources not associated with the apparatus), camera settings, or the like. The processor(s) 1402 may process any data gathered by the sensors regarding the ambient environment, and control lighting output of the light sources 1412. This lighting control may involve a binary output of whether light sources 1412 should be on or off. Additionally or alternatively, this lighting control may be involve adjusting the intensity of the outputted light.

The light sources 1412 may be configured to provide light when the lighting apparatus is against a wall portion as well. In other words, the lighting sources may provide light even if the apparatus is operating in glassboard mode. Accordingly, when the lighting apparatuses described herein are near a wall portion, they may operate as a conventional glassboard as well as an illuminated glassboard.

The processor(s) 1402 may also reference records or data stored in one or more databases 1406. For example, the database 1406 may store a record associated with a user indicating the user’s preferences of operational parameters for the light sources 1412. For example, the processor 1402 may control output of the light sources 1412 to operate with a certain intensity, color, etc.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A lighting apparatus comprising:
a transparent panel;
a light source configured to direct light into the transparent panel;
a structure supporting the transparent panel; and
a movement device configured to allow movement of the transparent panel between:
a first position in which the transparent panel is positioned at least substantially adjacent to a wall portion, and
a second position in which the transparent panel is positioned away from the wall portion to enable the lighting apparatus to function as a lightboard.

2. The lighting apparatus of claim 1 wherein the movement device includes a hinged portion in operable connectivity with the wall portion and with the frame, wherein the hinged portion enables the lighting apparatus to move between the first position and the second position.

3. The lighting apparatus of claim 2 further comprising a support wheel configured to support the frame and to assist in movement of the lighting apparatus between the first position and the second position.

4. The lighting apparatus of claim 1 wherein the movement device includes a portable rail assembly comprising:
an attachment mechanism configured to attach to the wall portion, and
a rail portion configured to engage the structure supporting the frame to enable movement of the frame.

5. The lighting apparatus of claim 1 wherein the movement device includes a rail portion in operable connectivity with the wall portion and the frame, wherein the movement of the rail portion enables the lighting apparatus to move between the first position and the second position.

6. The lighting apparatus of claim 1 wherein the movement device includes at least one wheel configured to move along a rail portion positioned below a floor surface.

7. The lighting apparatus of claim 1 further comprising:
at least one of:
a position detection device configured to detect a position of the transparent panel, or
a sensor to gather a parameter regarding the environment surrounding the apparatus; and
a control device configured to control output of the light source based on the detected position of the transparent panel or an output from the sensor.

8. The lighting apparatus of claim 1 wherein the movement device includes:
a base portion attached to the structure supporting the frame, and
a plurality of wheels configured to enable movement of the base portion, wherein the base portion includes a telescoping portion configured to move the base portion between a contracted state corresponding to the first position, and an extended state corresponding to the second position.

9. The lighting apparatus of claim 1 wherein the movement device includes:
a base portion attached to the structure supporting the frame,
a plurality of roller bearings positioned to enable movement of the support structure relative to the base portion to change the center of mass of the lighting apparatus.

10. The lighting apparatus of claim 1 wherein the movement device includes:
a base portion attached to the support structure;
a plurality of wheels configured to enable movement of the base, and
a telescoping arm portion configured to attach to the frame and to move the base portion between a contracted state corresponding to the first position, and an extended state corresponding to the second position.

11. A method of manufacturing a lighting apparatus, the method comprising:
positioning a transparent panel in a frame;
operably connecting a light source to the frame direct light into the transparent panel;
providing a structure to support the frame; and
configuring the structure or the frame with a movement device configured to allow movement of the frame between:
a first position in which the transparent panel is positioned at least substantially adjacent to a wall portion, and
a second position in which the transparent panel is positioned away from the wall portion to enable the lighting apparatus to function as a lightboard.

12. The method of claim 11 wherein the movement device includes a hinged portion in operable connectivity with the wall portion and with the frame, wherein the hinged portion enables the lighting apparatus to move between the first position and the second position.

13. The method of claim 12 further comprising providing a support wheel to support the frame and to assist in movement of the lighting apparatus between the first position and the second position.

14. The method of claim 11 wherein the movement device includes a portable rail assembly comprising:
an attachment mechanism configured to attach to the wall portion, and
a rail portion configured to engage a portion of the structure supporting the frame and enable movement of the frame.

15. The method of claim 11 wherein the movement device includes a rail portion in operable connectivity with the wall portion and the frame, wherein the movement of the rail portion enables the lighting apparatus to move between the first position and the second position.

16. The method of claim 11 wherein the movement device includes at least one wheel configured to move along a rail portion positioned below a floor surface.

17. The method of claim 11 further comprising configuring the lighting apparatus with:
at least one of:
a position detection device configured to detect a position of the transparent panel, or
sensor to gather a parameter regarding the environment surrounding the apparatus; and
a control device configured to control output of the light source based on the detected position of the transparent panel or an output from the sensor.

18. The method of claim 11 further comprising:
attaching a base portion to the structure supporting the frame, and
attaching a plurality of wheels configured to enable movement of the base portion, wherein the base portion includes a telescoping portion configured to move the base portion between a contracted state corresponding to the first position, and an extended state corresponding to the second position.

19. The method of claim 11 further comprising:
attaching a base portion to the structure supporting the frame, and
attaching a plurality of roller bearings positioned to enable movement of the support structure relative to the base portion to change the center of mass of the lighting apparatus.

20. The method of claim 11 further comprising:
attaching a base portion to the structure supporting the frame,
attaching a plurality of wheels to the base portion to enable movement of the base portion, and attaching a telescoping arm to the frame to enable the base portion to be moved between contracted state corresponding to the first position, and an extended state corresponding to the second position.
